(19) United States
(12) Patent Application Publication
(10) Pub. No.: US 2017/0124921 A1
(43) Pub. Date: May 4, 2017

(54) ELECTROLUMINESCENT SIGN, SYSTEM AND METHODS OF USE

(71) Applicant: Nolan Anelevitz, Toronto (CA)

(72) Inventor: Nolan Anelevitz, Toronto (CA)

(21) Appl. No.: 14/931,135

(22) Filed: Nov. 3, 2015

(51) Int. Cl. G09F 13/00; H05B 37/02; H05B 33/12; G09F 13/22; G09F 7/00

(52) U.S. Cl. CPC G09F 13/005; G09F 13/22; G09F 7/00; H05B 33/12; H05B 37/0218; H05B 37/0227; G09F 2007/005

(57) ABSTRACT

An electroluminescent sign and system are provided. The sign includes a panel having a front face and a rear face, the front face having a graphic image provided thereon and an illuminable image including an electroluminescent element; a power supply electrically connectable to the electroluminescent element; and a circuit including the power supply and a sensor operatively connected to the electroluminescent element. The electroluminescent element is illuminable upon an activation signal generated by the sensor. The sensor can include a motion sensor and/or a light sensor.

### FIELD OF THE INVENTION

The described embodiments relate to an electroluminescent sign, a system thereof and methods of use.

### BACKGROUND OF THE INVENTION

Electroluminescent signs have one or more illuminable sections that are typically intended to help attract attention to the overall display.

### BRIEF SUMMARY OF THE INVENTION

This summary is intended to introduce the reader to the more detailed description that follows and not to limit or define any claimed or as yet unclaimed invention. One or more inventions may reside in any combination or sub-combination of the elements or method steps disclosed in any part of this document including its claims and figures.

The various embodiments described herein generally relate to electroluminescent signs and the systems thereof.

In accordance with one aspect, an electroluminescent sign is provided with a sensor that regulates the illumination of one or more electroluminescent elements of the sign. For example, the sensor may actuate one or more electroluminescent elements of the sign or increase the level of illumination of one or more electroluminescent elements of the sign under particular lighting conditions, such as a low lighting conditions that may occur at twilight or on a cloudy day. Such a sensor may be a twilight sensor or a light sensor. Alternately, or in addition, the sensor may actuate one or more electroluminescent elements of the sign when a person is detected in the vicinity (e.g., within viewing range of the sign). Such a sensor may be a motion sensor.

An advantage of this aspect is that the sign may be actuated when a person is nearby so as to attract attention to the sign. If the sign were illuminated at all times, then a passerby may not take notice of the sign. However, if the illumination level changes when a person is in viewing range of the sign (e.g., one or more electroluminescent elements of the sign are turned on or the level of illumination is increased), then it is more likely that a passerby will notice the sign.

Another advantage is that the energy requirements of the sign may be reduced if it is not illuminated, or illuminated at a high intensity level at all times. Accordingly, by actuating one or more electroluminescent elements of the sign or increasing the level of illumination of one or more electroluminescent elements of the sign when motion is detected a predetermined distance from the sign the energy consumed by the sign will be reduced. This may enable the use of a smaller universal power supply (e.g., a battery pack or the like).

In accordance with this aspect, there is provided a sign comprising:

(a) a panel having a front face and a rear face, the front face having a graphic image provided thereon and an illuminable image including an electroluminescent element;

(b) a power supply electrically connectable to the electroluminescent element; and,

(c) a circuit including the power supply and a sensor operatively connected to the electroluminescent element, wherein the electroluminescent element is illuminable upon an activation signal generated by the sensor, and wherein the sensor includes at least one of a motion sensor and a light sensor.

In some embodiments, the electroluminescent element may be superimposed on the graphic image.

In some embodiments, the sensor may be the light sensor.

In some embodiments, the illuminable image may be different from the graphic image, whereby, during the day, only the graphic image may be visible and, during the night, only the illuminable image may be visible.

In some embodiments, the illuminable image may be different from the graphic image, the graphic image may be visible only during daytime and the illuminable image may be visible only during nighttime; and the light sensor may generate the activation signal in response to detecting the nighttime.

In some embodiments, the light sensor may be a twilight sensor.

In some embodiments, the illuminable image may be different from the graphic image, whereby, during the day, only the graphic image may be visible and, during the night, only the illuminable image may be visible.

In some embodiments, the illuminable image may be different from the graphic image, the graphic image may be visible only during daytime and the illuminable image may be visible only during nighttime; and the twilight sensor may generate the activation signal in response to detecting the nighttime.

In some embodiments, the sensor may be a motion sensor.

In some embodiments, the illuminable image may be illuminable in a pattern in response to the activation signal generated by the motion sensor.

In some embodiments, the pattern of the illuminable image may include illumination flashes in response to the activation signal generated by the motion sensor.

In some embodiments, the illuminable image may be illuminable upon issuance of a signal by the motion sensor in a pattern when actuated.

In some embodiments, a level of intensity of illumination of the illuminable image is increased in response to the activation signal generated by the motion sensor.

In some embodiments, the illuminable image may flash when actuated.

In some embodiments, the circuit may include an on/off switch.

In some embodiments, the power supply may include at least one battery.

In accordance with some embodiments, there is provided a method for operating a sign comprising:

(a) providing a panel having a graphic image provided thereon and an illuminable image including an electroluminescent element, and a circuit associated with the panel, the circuit including a power supply electrically connected to the electroluminescent element for driving the electroluminescent element and a sensor operatively connected to the electroluminescent element; and

(b) operating the sensor to detect an activation event, the electroluminescent element being illuminable in response to detecting the activation event; and in response to detecting the activation event, generate an activation signal for causing the electroluminescent element to be illuminated.

In some embodiments, the sensor may be a light sensor, and the illuminable image may be different from the graphic image, the graphic image may be visible only during daytime and the illuminable image may be visible only during nighttime; and operating the sensor to detect the activation event may include monitoring for nighttime to occur; and in response to detecting nighttime, generating the activation signal.

In some embodiments, the light sensor may be a twilight sensor.

In some embodiments, the sensor may be a motion sensor; and operating the sensor to detect the activation event may include monitoring for a movement within a detection range; and in response to detecting the movement is within the detection range, generating the activation signal.

In some embodiments, operating the sensor to generate the activation signal may include generating a pattern triggering signal for causing the illuminable image to be illuminated in a pattern.

In some embodiments, the pattern of the Illuminable image may include illumination flashes.

### BRIEF DESCRIPTION OF THE SEVERAL VIEWS OF THE DRAWINGS

The drawings included herewith are for illustrating various examples of articles, methods, and apparatuses of the teaching of the present specification and are not intended to limit the scope of what is taught in any way.

In the drawings:

FIG. 1 is an exploded view of an electroluminescent sign in accordance with an example embodiment;

FIG. 2A is rear view of an example panel of the electroluminescent sign shown in FIG. 1;

FIG. 2B is a front view of the example panel shown in FIG. 2A;

FIG. 3A is a front view of an example electroluminescent sign at a first operating state in accordance with an example embodiment;

FIG. 3B shows the electroluminescent sign in FIG. 3A at a second operating state;

FIG. 4A is a front view of an example electroluminescent sign at a first operating state in accordance with another example embodiment;

FIG. 4B shows the electroluminescent sign in FIG. 4A at a second operating state; and,

FIG. 4C shows the electroluminescent sign in FIG. 4A at a third operating state.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION

It will be appreciated that numerous specific details are set forth in order to provide a thorough understanding of the example embodiments described herein. However, it will be understood by those of ordinary skill in the art that the embodiments described herein may be practiced without one or more of these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The various embodiments described herein generally relate to electroluminescent signs and associated systems and methods for operating the described electroluminescent signs. The electroluminescent signs described herein may operate in response to the detection of one or more predefined events. The operation of the electroluminescent signs, therefore, can be more informed. Traditionally, the illuminable portions of electroluminescent signs are illuminated continuously with minimal consideration of the surrounding environment. As a result, unnecessary power is consumed and the life of the electroluminescent elements is also unnecessarily shortened due to the continuous illumination. The electroluminescent elements described herein may be illuminated upon the occurrence of predefined events within the surrounding environment. Since the electroluminescent elements need not be continuously illuminated, energy may be conserved and the life of the electroluminescent elements may be extended.

The different operating states that are available with the electroluminescent signs described herein facilitate a greater variety of applications of the electroluminescent signs. For example, some example embodiments of the electroluminescent signs may operate based on detection of a level of ambient light. The electroluminescent signs may include a graphic image that may be visible only during the daytime and an illuminable image that may be visible only during the nighttime, and the sensor may operate to detect the relevant activation event for the electroluminescent sign. Alternately, or in addition, in some other example embodiments, the electroluminescent signs may operate based on motion detection. The illuminable image of the electroluminescent signs may be activated when the sensor detects a movement within a predefined detection range from the electroluminescent sign.

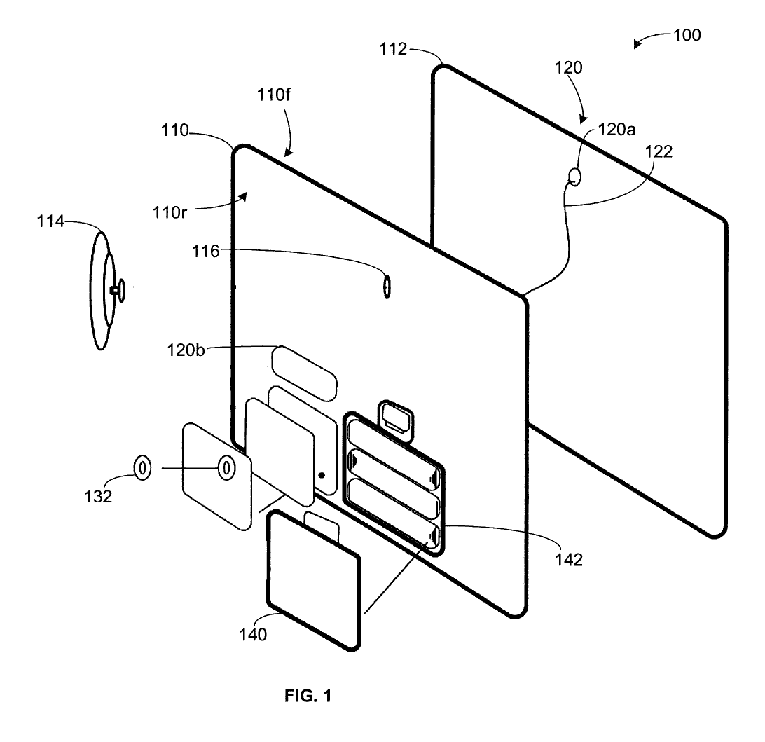

Reference is now made to FIG. 1, which is an exploded view of an electroluminescent sign 100.

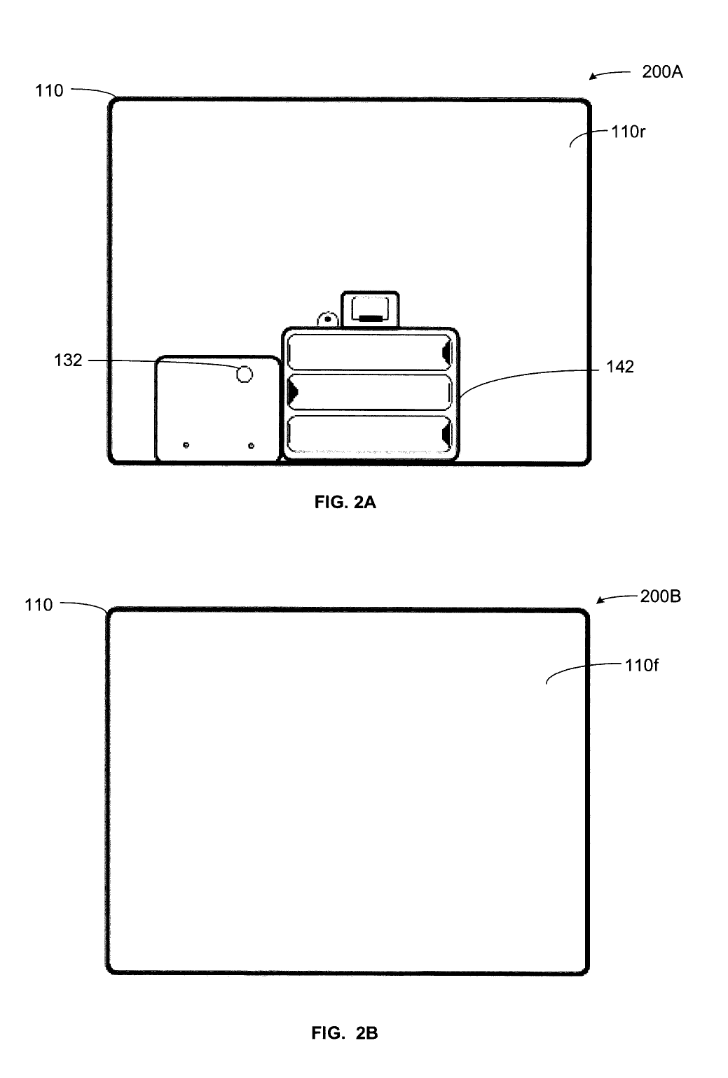

As exemplified, the electroluminescent sign 100 includes a panel 110 with a front face 110f and a rear face 110r. FIGS. 2A and 2B show the respective rear view 200A and front view 200B of the panel 110 of the electroluminescent sign 100.

The panel 110 may optionally include an opening 116 for receiving an attachment member 114, such as a suction cup, for attaching the electroluminescent sign 100 to a surface, such as a wall or door. It will be understood that other similar attachment members may be used with the electroluminescent sign 100 and that an opening 116 need not be provided. For example, an adhesive, such may be a releasable adhesive and/or a pressure sensitive adhesive may be used. Alternately or in addition a hanging system, such as are used with paintings or the like may be used. Alternately or in addition, a frame may be provided for securing the sign to a support inserted into the ground.

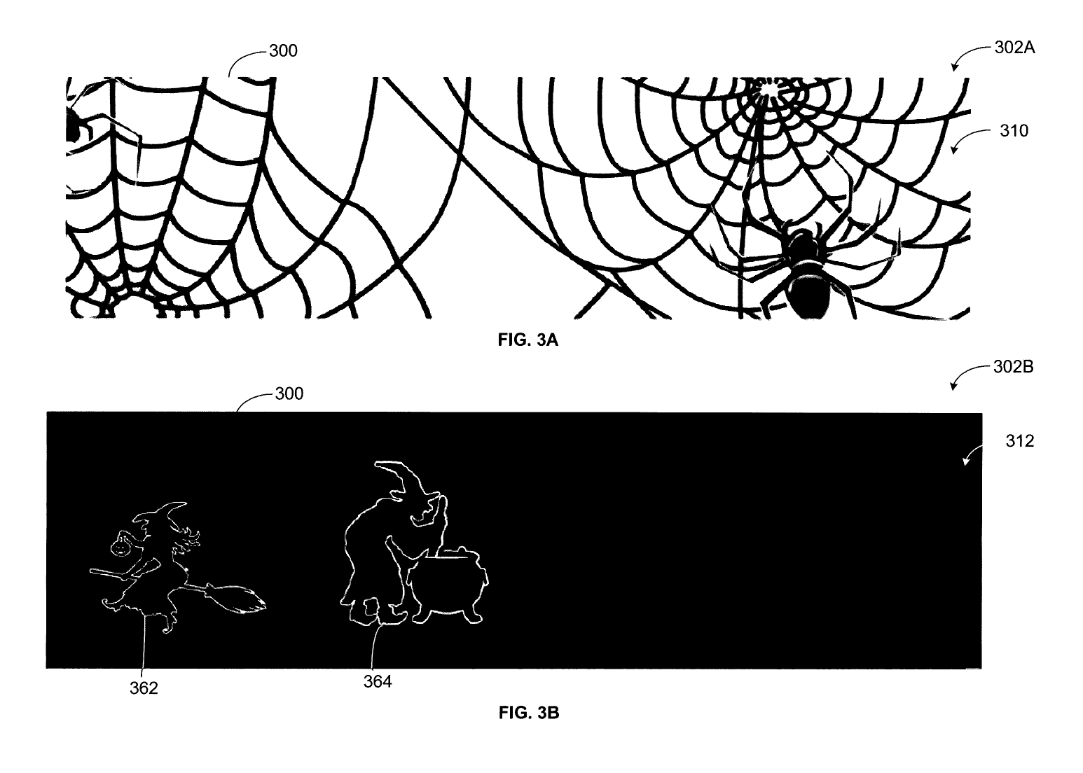

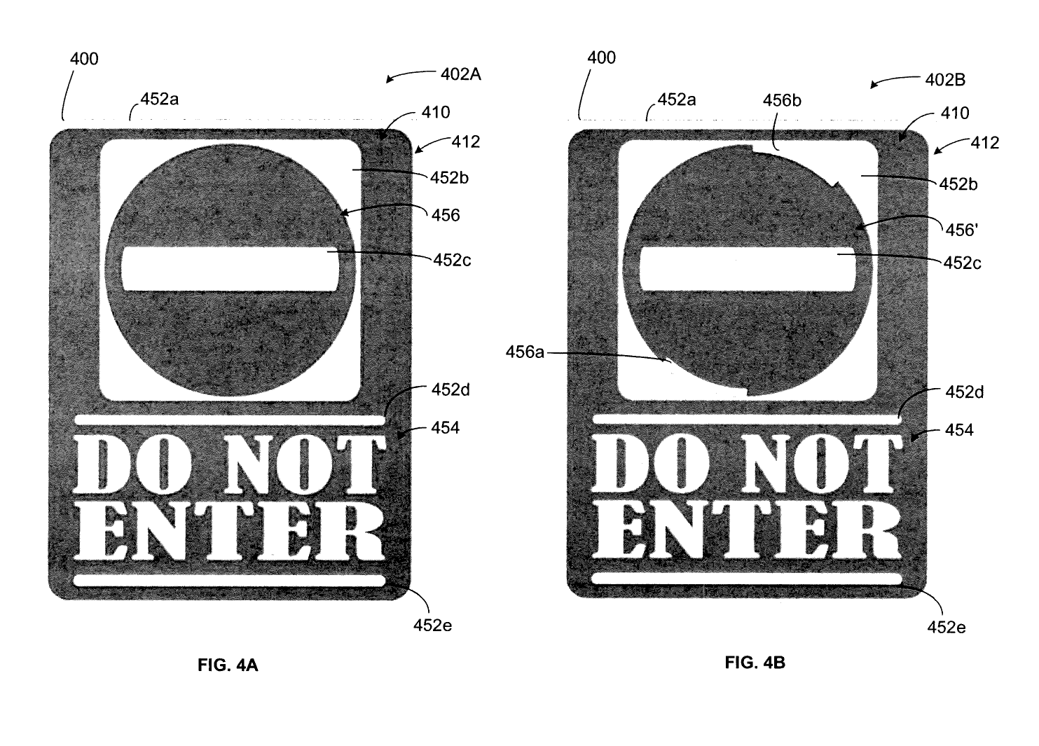

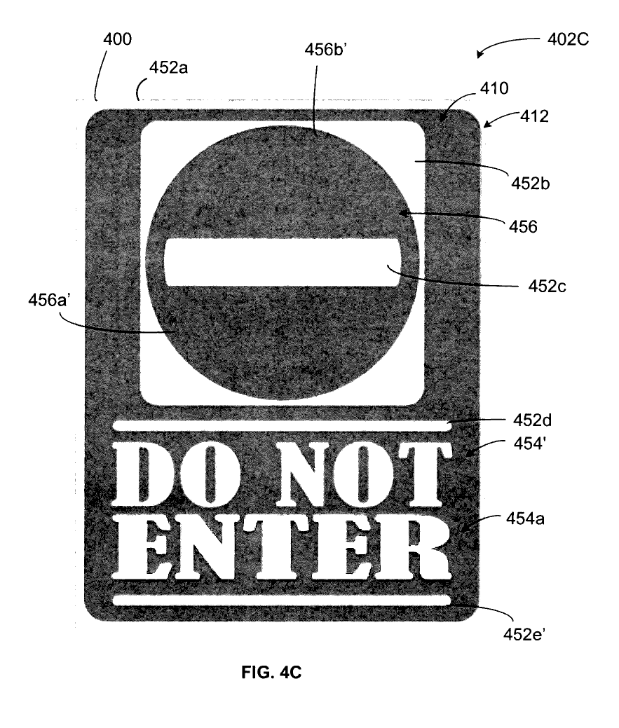

As exemplified in FIG. 1, the electroluminescent sign 100 includes an image component 112 that may be provided at or on the front face 110f. The image component 112 may include a graphic image and an illuminable image (not shown in FIG. 1). The illuminable image may include one or more electroluminescent elements. In some embodiments, such as the example described with reference to FIGS. 3A and 3B, the electroluminescent element may be superimposed on the graphic image and may complement the graphic image so as to emphasize elements thereof or may be an unrelated image. Example embodiments of the image component 112 will be described with reference to FIGS. 3A to 4C.

The electroluminescent sign 100 may also include a circuit for defining the operating parameters of the electroluminescent sign 100. The circuit may be positioned in association with the panel 110. The circuit may be mounted to the panel 110 or positioned separately from the panel 110. The circuit may include at least a sensor 120 and a power supply 142. The circuit may also include an on/off switch 132 actuable for turning the electroluminescent sign 100 on and off.

The power supply 142 is electrically connected to the one or more electroluminescent elements of the illuminable image for driving the one or more electroluminescent elements in response to one or more signals generated by the circuit. For example, the power supply 142 may operate to drive the electroluminescent element in response to one or more data signals generated by one or more sensors 120. As exemplified, the power supply 142 is an on board power supply, such as at least one battery. A power supply cover 140 can be provided to enclose the power supply 142 at the panel 110. Alternately, the power supply need not be attached to the sign and, optionally, the sign may have a socket or cord so as to enable the sign to be connectable to an external power source, such ads an AC outlet.

The sensor 120 is operatively connected to the one or more electroluminescent elements of the illuminable image. As shown in FIG. 1, the sensor 120 may include multiple components, such as a sensing component 120a and a sensor controller 120b. As shown in FIG. 1, the sensing component 120a and the sensor controller 120b may be electrically connected via a sensor connection 122, such as a wire.

The sensing component 120a may include one or more different sensors, such as a motion sensor, a light sensor and/or a sound sensor. The light sensor may be or include a twilight sensor. Some embodiments of the panel 110 may include an expansion slot for receiving supplemental sensors.

During operation of the electroluminescent sign 100, the sensing component 120a operates to monitor for an activation event. The activation event varies with the type of sensing component 120a that is provided for the electroluminescent sign 100. For example, the activation event may include detecting a movement within a movement detection range when the sensing component 120a includes a motion sensor, a time of day and/or a level of daylight illumination (cloudy versus sunny) when the sensing component 120a includes a light sensor, and detecting sound within a sound detection range when the sensing component 120a includes a sound sensor.

In response to detecting the occurrence of the activation event, the sensing component 120a may trigger the sensor controller 120b to generate an activation signal. The sensor controller 120b may be positioned in association with the panel 110 for defining the operating parameters of the sensor 120 and/or defining the illumination of the electroluminescent element. Upon generation of the activation signal by the sensor controller 120b, the one or more electroluminescent elements may be illuminated of the level of illumination may be increased. It will be appreciated that if a plurality of electroluminescent elements are provided then only one or more of the electroluminescent elements may be so actuated.

Various aspects of the illumination of the electroluminescent element can be varied, in some embodiments. For example, a level (intensity) of the illumination of one or more electroluminescent elements may be varied with the amount of current that is driven to the electroluminescent element to produce, e.g., brightening, fading, and/or glowing patterns. A duration of the illumination of the electroluminescent element can also be varied to produce, e.g., flickering and/or flashing patterns. The pattern of the illumination may include variation in both the level and the duration of the illumination of the electroluminescent element.

Reference will now be made to FIGS. 3A and 3B, which show an example electroluminescent sign 300 at different operating states. FIG. 3A shows the electroluminescent sign 300 at a first operating state 302A while FIG. 3B shows the electroluminescent sign 300 at a second operating state 302B. The sensor 120 of the electroluminescent sign 300 includes a light sensor (not shown in FIGS. 3A and 3B).

The light sensor may be programmed to monitor the light within the surrounding environment of the electroluminescent sign 300 to detect a time of day. For example, the light sensor may monitor the amount of light in the surrounding environment to determine whether a daytime threshold is satisfied. The daytime threshold may be a minimum amount of light that needs to be detected in order for the light sensor to determine the time of day is daytime. Otherwise, the light sensor may determine that the time of day is nighttime.

The electroluminescent sign 300 shown in FIG. 3A is operating at the first operating state 302A, which is the daytime operating state. During the daytime operating state 302A, the graphic image 310 generally shown in FIG. 3A is visible while the illuminable image 312 (shown in FIG. 3B) is not visible (e.g., the electroluminescent elements may not be actuated). When the light sensor detects the activation event, which is when the daytime threshold is no longer satisfied, the light sensor may determine that the time of day is nighttime and generate the activation signal to cause the one or more electroluminescent elements of the electroluminescent sign 300 to be illuminated. This is the second operating state 302B (nighttime operating state) exemplified in FIG. 3B. In this operating state, the illuminable image 312 is visible when the sensor 120 detects the activation event (i.e., nighttime) and generates the activation signal for causing the electroluminescent elements, such as 362, 364, to be illuminated. The graphic image 310 (which is not illuminable) is not visible when the activation event is detected (i.e., during the nighttime).

As shown in FIGS. 3A and 3B, the graphic image 310 and illuminable image 312 are different. The graphic image 310 and illuminable image 312 are visible at different operating states of the electroluminescent sign 300. The illuminable image 312 may be superimposed on the graphic image 310 in some embodiments.

The sensing component 120a may, in some embodiments, include a motion sensor. FIGS. 4A to 4C show an example electroluminescent sign 400 at different operating states.

The electroluminescent sign 400 may include a graphic image 410 and an illuminable image shown generally as 412. The illuminable image 412 includes an electroluminescent element with multiple electroluminescent segments, such as 452a, 452b, 452c, 452d, 452e, 454 and 456. In some embodiments, the electroluminescent segments 452a, 452b, 452c, 452d, 452e, 454 and 456 may be illuminated in a pattern.

The motion sensor may be programmed to monitor for movement within a movement detection range within the surrounding environment of the electroluminescent sign 400, and to generate the activation signal in response to detecting the movement within the movement detection range. As a result, the electroluminescent element in the electroluminescent sign 400 may be illuminated in response to the activation signal.

The movement detection range may, in some embodiments, be approximately within 30 feet of the electroluminescent sign 400.

In some embodiments, the illumination signal may include a pattern triggering signal for causing the illuminable image 412 to be illuminated in a pattern. FIG. 4A, for example, shows the electroluminescent segment 452e in the electroluminescent sign 400 is illuminated at a first operating state 402A. Other electroluminescent segments, such as 456a and 456b, may become illuminated at a later operating state, such as a second operating state 402B shown in FIG. 4B. At a further operating state, such as a third operating state 402C in FIG. 4C, the electroluminescent segments 452e′, 456a′ and 456b′ may no longer be illuminated and only the electroluminescent segments shown generally as 454a may be illuminated. The pattern in which the electroluminescent segments 452a, 452b, 452c, 452d, 452e, 454 and 456 are illuminated may help to attract the attention of nearby bystanders, and may emphasize the message being conveyed by the graphic image 410 and/or illuminable image 412, if any.

In some embodiments, the illumination pattern of the electroluminescent element may involve flashing. For example, all the electroluminescent segments, such as 452a, 452b, 452c, 452d, 452e, 454 and 456, may be alternately illuminated in a predefined pattern, or simultaneously illuminated in a predefined pattern. The pattern of the illumination may include variation in both the level (strength) of illumination and/or the duration of the illumination of the electroluminescent segments, such as 452a, 452b, 452c, 452d, 452e, 454 and 456.

In some embodiments, the pattern of the illumination of the electroluminescent segments, such as 452a, 452b, 452c, 452d, 452e, 454 and 456, may vary with the proximity of the movement detected by the motion sensor. The pattern may increase in intensity as the movement approaches the electroluminescent sign 400 and decreases in intensity as the movement moves away from the electroluminescent sign 400, or vice versa.

In some embodiments, the activation signal may trigger the illumination for only a predefined time period, such as 40 seconds, when no further movement is detected during that predefined time period.

The sound sensor may be triggered to generate the activation signal in response to detecting a sound within a sound detection range. The electroluminescent element may be illuminated in response to the activation signal. The sound detection range may be approximately within 10 feet of the electroluminescent sign 100. In some embodiments, the activation signal may trigger the illumination only for a predefined time period, such as 40 seconds, when no further sound is detected during that predefined time period.

In some embodiments, the circuit may include a main controller 130. The main controller 130 may include an internal clock for triggering operation of the electroluminescent sign 100 during predefined time periods. For example, the internal clock may be programmed to trigger operation of the electroluminescent sign 100 during the weekdays from 9 am to 5 pm to conserve energy and maximize exposure.

What has been described above has been intended to be illustrative of the invention and non-limiting and it will be understood by persons skilled in the art that other variants and modifications may be made without departing from the scope of the invention as defined in the claims appended hereto. It will be appreciated that the elements disclosed herein may be used in any combination or sub-combination of elements. The scope of the claims should not be limited by the preferred embodiments and examples, but should be given the broadest interpretation consistent with the description as a whole.

1. A sign comprising:
(a) a panel having a front face and a rear face, the front face having a graphic image provided thereon and an illuminable image comprising an electroluminescent element;
(b) a power supply electrically connectable to the electroluminescent element; and,
(c) a circuit including the power supply and a sensor operatively connected to the electroluminescent element, wherein the electroluminescent element is illuminable upon an activation signal generated by the sensor, and wherein the sensor comprises at least one of a motion sensor and a light sensor.

2. The sign of claim 1, wherein the electroluminescent element is superimposed on the graphic image.

3. The sign of claim 1, wherein the sensor comprises the light sensor.

4. The sign of claim 3, wherein the illuminable image is different from the graphic image, whereby, during the day, only the graphic image is visible and, during the night, only the illuminable image is visible.

5. The sign of claim 3, wherein the illuminable image is different from the graphic image, the graphic image being visible only during daytime and the illuminable image being visible only during nighttime and the light sensor generates the activation signal in response to detecting the nighttime.

6. The sign of claim 1, wherein the light sensor comprises a twilight sensor.

7. The sign of claim 6, wherein the illuminable image is different from the graphic image, whereby, during the day, only the graphic image is visible and, during the night, only the illuminable image is visible.

8. The sign of claim 6, wherein the illuminable image is different from the graphic image, the graphic image being visible only during daytime and the illuminable image being visible only during nighttime and the twilight sensor generates the activation signal in response to detecting the nighttime.

9. The sign of claim 1, wherein the sensor comprises the motion sensor.

10. The sign of claim 1, wherein the illuminable image is illuminable in a pattern in response to the activation signal generated by the motion sensor.

11. The sign of claim 1, wherein a level of intensity of illumination of the illuminable image is increased in response to the activation signal generated by the motion sensor.

12. The sign of claim 10, wherein the pattern of the illuminable image comprises illumination flashes in response to the activation signal generated by the motion sensor.

13. The sign of claim 9, wherein the illuminable image is illuminable upon issuance of a signal by the motion sensor in a pattern when actuated.

14. The sign of claim 13, wherein the illuminable image flashes when actuated.

15. The sign of claim 1, wherein the circuit further comprises an on/off switch.

16. The sign of claim 1, wherein the power supply comprises at least one battery.

17. A method of operating a sign, the method comprising:
(a) providing a panel having:
(i) a graphic image provided thereon and an illuminable image comprising an electroluminescent element, and,
(ii) a circuit associated with the panel, the circuit including:
(1) a power supply electrically connected to the electroluminescent element for driving the electroluminescent element; and,
(2) a sensor operatively connected to the electroluminescent element; and,
(b) operating the sensor to:
(i) detect an activation event, the electroluminescent element being illuminable in response to detecting the activation event; and,
(ii) in response to detecting the activation event, generate an activation signal for causing the electroluminescent element to be illuminated.

18. The method of claim 17, wherein the sensor comprises a light sensor, and the illuminable image is different from the graphic image, the graphic image being visible only during daytime and the illuminable image being visible only during nighttime and operating the sensor to detect the activation event comprises:
(a) monitoring for nighttime to occur; and,
(b) in response to detecting nighttime, generating the activation signal.

19. The method of claim 18, wherein the light sensor comprises a twilight sensor.

20. The method of claim 19, wherein the sensor comprises a motion sensor; and operating the sensor to detect the activation event comprises:
(a) monitoring for a movement within a detection range; and
(b) in response to detecting the movement is within the detection range, generating the activation signal.

21. The method of claim 20, wherein operating the sensor to generate the activation signal comprises:
generating a pattern triggering signal for causing the illuminable image to be illuminated in a pattern.

22. The method of claim 21, wherein the pattern of the illuminable image comprises illumination flashes.
